(19) United States
(12) Patent Application Publication
(10) Pub. No.: US 2018/0141319 A1
(43) Pub. Date: May 24, 2018

(54) PROCESS FOR THE PRODUCTION OF MULTI-LAYER PAPERBOARD AND MULTI-LAYER PAPERBOARD OBTAINED

(71) Applicant: INNVENTIA AB, Stockholm (SE)

(72) Inventors: Mikael Ankerfors, Upplands Väsby (SE); Tom Lindström, Sollentuna (SE); Gunborg Glad-Nordmark, Sollentuna (SE)

(21) Appl. No.: 15/574,978

(22) PCT Filed: May 19, 2016
(86) PCT No.: PCT/SE2016/050459

§ 371 Date: Nov. 17, 2017

(30) Foreign Application Priority Data
May 22, 2015 (SE) 1550655-3

(51) Int. Cl. B32B 29/00; D21H 17/66; D21H 27/30; D21H 27/10; B65D 65/38

(52) U.S. Cl. CPC B32B 29/005; D21H 17/66; D21H 27/30; D21H 27/10; B32B 2307/72; B32B 2250/26; B32B 2262/067; B32B 2553/00; B65D 65/38

(57) ABSTRACT

The present invention relates to a process for the production of a bulky multi-layer paperboard comprising a middle layer produced from a cured pulp product produced by a method comprising the steps of:
i) providing a first aqueous pulp slurry comprising cellulosic fibres and having a pulp consistency of from 0.1% to 40% by weight, calculated as dry weight of the cellulosic fibres in the first pulp slurry;
ii) adding to the first pulp slurry an aluminium metal salt comprising Al³⁺-ions to a total molar concentration of aluminium ions of from 0.0001 M to 0.5 M in the first pulp slurry;
iii) adjusting the pH of the first pulp slurry to a pH of from pH 3.0 to pH 6.0;
iv) dewatering and curing the first pulp slurry at a temperature of at least 60° C. and thus provide a cured pulp product.

### TECHNICAL FIELD

The present invention relates to a process for the production of a cured pulp product for use in the production of a multi-layer paperboard product, as defined in the appended claims.

### BACKGROUND

Packaging materials of paperboard have been used for a long time for packing different goods to provide mechanical and/or chemical protection for the goods. There is a growing demand for light-weight packaging materials, which have good mechanical strength to ensure sufficient protection of the goods.

Bulking fibres have historically been used and developed in the field of tissue manufacture, where soft structures have a particular consumer value. Typical treatments involve cross-linking agents, such as citric acid/catalysts and/or curling treatments. Also, some development work to lower the density of board materials has been made in connection with cellulosic fibre-board materials used as heat insulating, sound insulating, or cushioning materials. However, such materials would not be suitable for use as packaging material since e.g. it does not fulfil the same requirements for mechanical properties as packaging materials. For example, document JP S54-138060 discloses a method for manufacturing a low-density flame-retardant cellulosic fibre-board for use as heat or sound insulation material or as a cushioning material. In the method a wood pulp is first impregnated with an aqueous solution of ammonium phosphate to render the board material incombustible. The wood pulp is then dried and heated to 130-170° C. to obtain cellulose phosphate. The cellulose phosphate is then re-slushed to a concentration of 2.5% and the cellulose phosphate is beaten in water. The pH is then adjusted to pH 2.7 to 6.5 by using a multivalent metal salt, such as aluminium sulphate. The slurry is then formed to a fibreboard, dewatered and dried at a temperature of 100-125° C. for 1 to 3 hours. Due to the treatment, the fibre bundle can get an increased volume and thus the board may get a low density. However, the metal salt is added to the obtained cellulose phosphate after the cured phosphate-impregnated web is re-slushed and before the dewatering of the final board material web. Also, ammonium phosphate is used as a flame retardant and therefore, there is a need to find materials that are suitable for use in packaging materials and which are environmentally friendly and safe to use in working environments.

Thus, even though there are known methods to increase bulk of fibres, there is a need to provide a process suitable for use in connection with the production of paperboard, especially packaging board.

### SUMMARY OF THE INVENTION

It is an object of the present invention to provide low density paperboard suitable for use as packaging material.

It is an object with the present invention to provide a process for the production of a cured pulp product in which fibres are treated to obtain bulking fibres.

It is also an object of the present invention to minimize problems identified in connection with the production of prior art low density materials.

According to the present invention, cellulosic fibres are treated to obtain light-weighting of a cellulosic material. The treatment provides “bulking fibres”, which can be used to make bulky paperboard materials while the bending stiffness can be maintained with a lower basis weight. Alternatively, the bulking fibres may be used to increase the bending stiffness with a maintained basis weight.

It is an object of the present invention to provide a process for the production of a multi-layer paperboard with low density, i.e. with high bulk, from the cured pulp product. The density of the paperboard will be low, while the bending stiffness of the paperboard material can be at least maintained, especially by the use of dry-strength agents in a paperboard making process, at the same level as compared to a material having a higher density.

It is also an object of the present invention to provide a treatment method for pulp which results in a significant lowering of the water retention value in a subsequent papermaking process, which is beneficial for the dewatering and pressing efficiencies, resulting in a higher dry content after the press-section. Thereby, the need for drying energy in the drying process during paperboard manufacture can be decreased. Hence, if the treatment step takes place in a pulp mill, and the pulp is used in a non-integrated paper/board mill, the resource efficiency during the paperboard manufacture will be much higher both in terms of material and energy efficiency.

Further objects and advantages will be apparent from the following disclosure of the present invention.

The objects above are attained by a process according to the present invention defined in the appended claims, which according to a first aspect relates to a process for the production of a multi-layer paperboard comprising at least three layers comprising a top layer, middle layer and bottom layer, the process comprising the steps of:
i) providing a first aqueous pulp slurry comprising cellulosic fibres and having a pulp consistency of from 0.1 to 40% by weight, calculated as dry weight of the cellulosic fibres in the first pulp slurry;
ii) adding to the first pulp slurry an aluminium metal salt comprising Al³⁺-ions to a total molar concentration of aluminium ions of from 0.0001 M to 0.5 M in the first pulp slurry;
iii) optionally adjusting the pH of the first pulp slurry to a pH of from pH 3.0 to pH 6.0;
iv) dewatering and curing the first pulp slurry at a temperature of at least 60° C. and thus provide a cured pulp product;
v) providing the cured pulp product to a process for the production of paperboard;
vi) re-slushing the cured pulp product to provide an aqueous second pulp slurry
vii) pumping the second pulp slurry to a wire section of a paperboard machine to form the middle layer of the multi-layer paperboard, and pumping pulp slurries for the other layers of the multi-layer paperboard to the wire section of a paperboard machine;
viii) dewatering the aqueous second pulp slurry and the pulp slurries for the other layers of multi-layer paperboard and provide a web of pulp;
ix) drying the web of pulp to provide a dried multi-layer paperboard.

In the process, when the fibres are treated with aluminium ions (cations) in acidic conditions in steps ii) and iii), the hornification of the fibres increases and thereby stiffer fibres are obtained. Hornification refers to an irreversible internal bonding in lignocellulosic fibre materials that takes place upon water removal or drying/curing. The hornified fibres do not swell to the same extent as the non-hornified fibres (i.e. they cannot take up as much water) and this difference can e.g. be measured as a decrease in water retention value. The irreversible bonding also leads to a stiffening of the polymer structure in the fibres and papers made from stiffer fibres are bulkier. Thus, the process according to the first aspect of the invention provides bulking fibres and leads to webs that are easy to dewater during a papermaking process.

It should be noted that in the present application, when an interval from a first value to a second value is described, it is meant that any individual value within the claimed interval may be chosen, including the end values. For example, regarding the pulp consistency in the interval “of from 0.1 to 40% by weight”, it is meant that any value within the interval, such as 0.1%, 10%, or 40% may be chosen for the pulp consistency. Further as an example and in a corresponding way the pH may be chosen to be any pH value within the claimed interval of from 3.0 to 6.0 and can be for example pH 3.0, 3.5, pH 5.0, or pH 6.0.

According to one embodiment the first pulp slurry is dewatered and subsequently or concurrently cured by means of flash drying. Flash drying is suitably performed at a temperature that is higher than for example when drying by means of heated cylinders, and the temperature can be from 100 to 300° C., depending on the heat sensitivity of the pulp slurry. Also the curing time is normally short when flash drying is used. By flash drying a further bulking effect, i.e. a higher bulk with lower density, may be obtained. Thus, in the step iv) of the process the first pulp slurry can be cured by means of flash drying at a temperature of from 100° C. to 300° C., preferably from 150° C. to 270° C., and most preferably from 180° C. to 240° C. The curing time can be less than 5 minutes, preferably less than one minute. Therefore, essentially shorter curing time may be obtained compared to traditional curing methods.

According to another embodiment, in the step iv) of the process the first pulp slurry is cured at a temperature of from 60 to 150° C. by means of heated air or steam. The heated air or steam can be lead directly to heat the first pulp slurry or indirectly to heat the first pulp slurry, for example by means of air or steam heated cylinders. The higher the temperature during the curing is, the higher will the bulk be and thus the bulking effect. By using heated air or steam as curing methods in the step iv) of the process, it is possible to provide a cured pulp product in the form of a web, i.e. a cured web. The web may then be collected and rolled up to web rolls and then provided to a papermaking mill. The process may then further comprise a step x) comprising cutting the cured web into sheets and stacking the sheets to provide bales of pulp. The bales of pulp are easy to transport to a paperboard mill and can be readily used in a papermaking process.

In the process in the step iv) the web of pulp is preferably cured until a moisture content of below 50%, suitably below 30%, and preferably below 15% is obtained. The moisture content may be 0%, but usually the moisture content is about 1 to 10%. The more the web is cured, the greater will the density decrease of the final material produced be and thus the greater the bulking effect obtained.

The aluminium metal salt comprising aluminium ions (Al³⁺) is preferably added to the first pulp slurry in the step ii) to a total molar concentration of aluminium ions of from 0.0001 to 0.05 M in the first pulp slurry, which is sufficient to obtain bulking effect while the risk for deteriorating the quality of the fibres is minimized.

The pulp consistency of the first aqueous pulp slurry during the treatment can be from 0.5% to 30%, preferably from 1% to 20%, calculated as dry weight of the cellulosic fibres in the first pulp slurry. Preferably, the pulp concentration is as high as possible, whereby a more effective ion exchange can be achieved, and thus the concentration of the added metal salt can be kept at a low level.

In the process, the cellulosic fibres may comprise softwood, hardwood, recycled fibres, or non-wood fibres suitable for making the multi-layer paperboard. The first aqueous pulp slurry may comprise or consist of a chemical pulp selected from a kraft, soda, or sulfite pulp. The pulp may also comprise or consist of a mechanical pulp, a thermomechanical pulp, a semi-chemical pulp, or a chemi-thermomechanical pulp, or mixtures thereof. The pulp may be unbleached or bleached pulp. Preferably, the pulp is kraft pulp, whereby high quality paperboard can be obtained.

From the process steps i)-iv) as described above a cured pulp product is obtained which will provide a higher bulk for a final product after re-slushing in a paperboard making process than an untreated cured pulp product.

As defined in the steps above, the cured pulp product is then re-slushed to provide aqueous second pulp slurry, which is pumped to a wire section of a paperboard machine to form the middle layer of the multi-layer paperboard. Pulp slurries for the other layers of the multi-layer paperboard are also pumped to the wire section of a paperboard machine. Preferably, the pumping occurs simultaneously from respective headboxes to respective wires. The aqueous second pulp slurry and the pulp slurries for the other layers of the multi-layer paperboard are then dewatered to provide a web of pulp and finally the web of pulp is dried to provide a dried multi-layer paperboard.

To enhance the strength of the paperboard product during the process above, the process may further comprise adding a dry strength aid or a wet strength resin to the second pulp slurry, suitably for example between the steps vi) and viii). In this way the strength of the paperboard obtained may be improved while still maintaining an improved bulking effect.

The present invention also relates to a multi-layer paperboard obtained by the process as defined above.

The paperboard may have a structural density of from 150 to 600 kg/m³ according to SCAN-P-88:01, whereby a low density product can be provided e.g. for packaging purposes.

Further features and advantages of the present invention are described in the following detailed description and examples with reference to the appended drawings.

### BRIEF DESCRIPTION OF THE DRAWINGS

FIG. 1 is a flow chart, which shows the main steps of the present process.

FIG. 2 shows a graph, which illustrates how water retention value varies with pH and different metal ion concentrations (M) of Al³⁺ after curing for 2 hours at 120° C.

FIG. 3 shows a graph which illustrates how the water retention value varies with sheet density of paper (the second web) made from the cured pulp product at different metal ion concentrations (M) of Al³⁺.

### DETAILED DESCRIPTION

There is a long-time felt need for lighter and stronger paper-based materials, such as packaging materials. The inventors of the present invention have found an economical and efficient process that increases the bulk of paperboard materials and thus provides lighter packaging material while the mechanical properties of the material can be maintained sufficiently by using chemical additives for packaging purposes.

Paperboard relates to a material made from pulp comprising cellulosic fibres. Paperboard is manufactured from cellulosic fibres by dewatering fibres on a wire, then pressing the moist web or webs together and then drying the webs into thin, flexible material. Paperboard may be a single layer product or it may be a multi-layer or multi-ply paperboard product comprising several layers containing pulp and thus fibres. Paperboard according to the present invention is a multi-layer paperboard comprising at least three layers, the layers being a top layer, middle layer and bottom layer, i.e. there are two surface layers. Multi-layer paperboard may comprise at least one or more middle layers, such as from 1 to 10 layers. Suitably the amount of middle layers is from 1 to 5 and most preferably 1, 2 or 3. Each layer containing fibres is formed by suitably pumping an aqueous pulp from a respective head-box to a wire section of a paperboard machine. The wire section of the paperboard machine may comprise one or more wires. Suitably, the paperboard machine comprises as many wires as it contains head-boxes, but a multi-layered web can also be produced using a single head-box able to produce a multi-layered web or sheet, thus decreasing the number of necessary wires for dewatering. In case of multi-wire solutions, the individual layers are couched. The formed wet web is then mainly dewatered in a press section of a paperboard machine and finally dried in a drying section of a paperboard machine. Paperboard normally has a grammage exceeding 200 g/m², suitably over 220 g/m². However, the grammage of the multi-layer paperboard of the present invention may be as low as 120 g/m², but is preferably at least 160g/m².

Cellulosic fibres are fibres originating from unbleached or bleached pulp comprising a pulp selected from a kraft, soda, sulfite, mechanical, a thermomechanical pulp (TMP), a semi-chemical pulp (e.g., neutral sulfite semi-chemical pulp; NSSC), a recycled pulp or a chemithermomechanical pulp (CTMP), or mixtures thereof. The raw material for the pulps can be based on softwood, hardwood, recycled fibres or non-wood fibres suitable for making paperboard/cardboard. The softwood tree species can be for example, but are not limited to: spruce, pine, fir, larch, cedar, and hemlock. Examples of hardwood species from which pulp useful as a starting material in the present invention can be derived include, but are not limited to: birch, oak, poplar, beech, eucalyptus, acacia, maple, alder, aspen, gum trees, and gmelina. Preferably, the raw material mainly comprises softwood. The raw material may comprise a mixture of different softwoods, e.g. pine and spruce. The raw material may also comprise a non-wood raw material, such as bamboo and bagasse. The raw material may also be a mixture of at least two of softwood, hardwood, and/or non-woods.

By pulp consistency is meant dry content in aqueous pulp slurry. That is, for example a consistency of 10% means that the weight of the dry matter is 10%, based on the total weight of the pulp slurry.

In the present process, the first pulp slurry produced is cured. By curing is meant in the present application that a physical or chemical reaction occurs in the material in addition to evaporation of water. By drying is meant evaporation of water from a material.

Dewatering is a procedure by which water is removed from a wet pulp web. Dewatering can be performed mechanically during the web formation on a wire for example by means of pressure, vacuum, or centrifugal forces. Dewatering is mainly performed by means of mechanical forces, e.g. by means of pressing, e.g. in a pressing section of a paperboard machine. After dewatering on a wire and/or mechanical dewatering, the web can be forwarded to a drying section, in which the remaining water/moisture in the web is evaporated by means of heat, which is also called thermal dewatering. The drying section may be designed in different ways and can comprise e.g. multi-cylinder dryer equipment.

By moisture content is meant the water content of the material expressed in weight %, and based on the total weight of the material.

By water retention value is meant a test value that provides an indication of fibres' ability to take up water and swell, and is in this application measured by means of a standard method SCAN-C 62:00, unless otherwise described.

In this application, the definition of re-pulping is used equally with re-slushing or re-slurrying and means that a cured pulp is re-suspended in water to provide an aqueous suspension containing cellulosic fibres.

In the present application by bulking fibres are meant fibres that after treatment obtain a more bulky material structure than fibres that have not been treated. By bulking effect is meant an effect which decreases a density of a material compared to a material that has not been treated.

By molar concentration is meant the concentration or the amount of a substance (mole) in one dm³ or litre of a mixture, e.g. molar concentration of metal ions equals to moles of the ions in one litre of an aqueous solution containing water and a metal salt.

Process Description

As already mentioned above, it is desirable to produce paperboard with higher bulk. However, despite prior art solutions, there is still a need to improve processes to produce bulky paperboard in an economical and efficient way. It is also desirable that existing process equipment can be used to produce paperboard and that process parameters are not affected greatly due to a bulking treatment of the pulp. It is thus essential that the characteristics of the treated pulp material used in paperboard mills do not negatively affect the production process. It is desirable that the paperboard production in the existing paperboard mills can be performed with as few modifications as possible.

By the present process, it is possible to provide a cured pulp product in the form of a web or bales of pulp for the further production of paperboard. The cured pulp product may also be in the form of a free flowing material, such as flakes.

The pulp is chemically treated so as to obtain bulking fibres. The first pulp product can then be provided to a paperboard mill. When the pulp is cured in acidic conditions and in the presence of aluminium ions, the internal structure of the pulp material can be stabilized before further processing of the pulp material. Therefore, the fibres show less swelling when re-slushed during paperboard manufacture than fibres that are not treated. Thus, for example a significant lowering of the water retention value can be obtained when the cured pulp product of the invention is used compared to a pulp material that is not cured. This is beneficial for the pressing efficiency in a paperboard machine. Thereby, a higher dry content after the press section in a paperboard machine may be obtained.

The present process has been found to provide an efficient way to produce pulp having a higher bulk than non-treated pulps. Also, the pulp can be mechanically pressed to higher solids content and therefore drying energy is saved. A further advantage is that that the productivity of drying-limited paperboard machines can be enhanced.

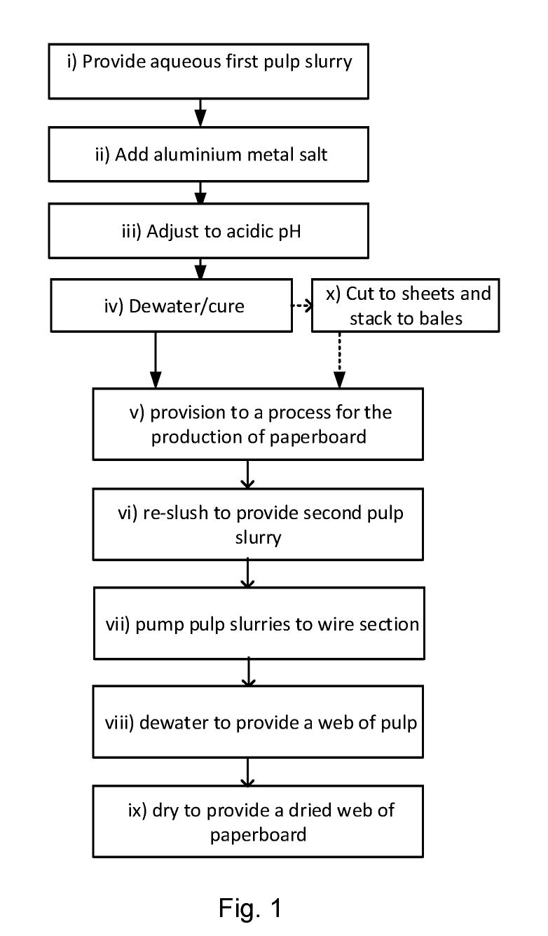

The present process is illustrated in FIG. 1 in which steps of the process are illustrated in a flow chart. By the present process a cured pulp product suitable for use for the production of paperboard can be provided. In the first step of the process, in step i), a first aqueous pulp slurry is provided. The first pulp slurry comprises cellulosic fibres and has a pulp consistency of from 0.1% to 40% by weight, calculated as a dry content of cellulosic fibres in the first pulp slurry. The first pulp slurry may thus be a low consistency pulp having a dry content between 1% to 4%, medium consistency pulp having a dry content between 8% to 12%, or high consistency pulp having a dry content between 20% to 40%. The pulp may also have a consistency in between the presented values if desired. Suitably the consistency is from 1% to 20%, calculated as a dry content of cellulosic fibres in the first pulp slurry.

The raw material may be selected from any of softwood, hardwood, recycled fibres or non-wood fibres that are suitable for making paperboard/cardboard or mixtures thereof. The first pulp slurry may comprise or consist of an unbleached or a bleached pulp which can comprise or consist of a chemical pulp such as a kraft (sulfate), soda or sulfite pulp. The pulp may also comprise or consist of a mechanical pulp, thermomechanical pulp (TMP), semi-chemical pulp (e.g., neutral sulfite semi-chemical pulp; NSSC), recycled pulp or chemi-thermomechanical pulp (CTMP). The pulp may consist of one type of pulp or the pulp may comprise two or more pulps as a mixture. Preferably, the cellulosic fibres originate from a chemical pulping process, which provides high quality pulps. Suitably, the fibres are derived from a kraft pulping process.

In the next process step ii) an aluminium metal salt comprising aluminium (Al³⁺) metal ions is added to the first pulp slurry. The metal salt is added to a total molar concentration of the aluminium ions in the first slurry of from 0.0001 M to 0.5 M. By adding the multivalent metal salt to the first pulp slurry, which is never-dried, bulking fibres can be provided. The structure of the fibres is stabilized after curing and thus a cured pulp product useable in a process for making paperboard products with higher bulk is obtained. Thus, it is possible to obtain low density paperboard materials.

The aluminium metal salt is preferably added to the pulp to a total molar concentration of metal ions from 0.0001 M to 0.05 M. By the addition of the aluminium salt it is also possible to adjust the pH of the pulp slurry towards an acidic pH.

The counter-ion in the multivalent metal salt in the step ii) may be any suitable counter-ion and can be for example selected from Cl⁻, NO₃⁻ or SO₄²⁻ or any other suitable counter-ion, which is dissociated from the multivalent metal ion in water. Such salts are also often used in papermaking and are suitable for the processes thereof.

After the addition of the aluminium metal salt, the pH of the first pulp slurry is controlled and optionally adjusted to a pH value in the interval from pH 3.0 to pH 6.0 in the step iii) of the process. If the pH is within the range of from pH 3.0 to pH 6.0 no addition of an additional acid is required. However, if the pH is not within the range and adjustment towards acidic pH is needed, the adjustment can be performed by using an acid or base which is other than the metal salt used in the step ii). For example, the acid may be sulphuric acid.

In one variant of the process according to the present invention in the step iii), which is after the optional adjustment of the pH, the slurry can be washed. In this way it is possible to remove excess ions from the slurry.

After the adjustment of the pH, the first pulp slurry is dewatered and cured in the step iv) of the process to provide a cured pulp product. The acidic condition during the dewatering and curing in the step iv) of the first pulp slurry increases the bulk of a paperboard made from the cured pulp product. This is caused by an increased hornification of the cellulosic fibres when cured under acidic conditions and especially in the presence of Al³⁺ ions. This means that the fibres become stiffer in aqueous suspensions than non-treated fibres. In addition to the chemical/physical reactions, since the curing temperature is at least 60° C., also water is evaporated. Therefore, the curing is performed until the moisture content is below 50%.

Preferably, the moisture content is below 30%, and most preferably below 15%. Normally, the pulp slurry is cured until a moisture content level from 0% to 5% is obtained. Due to practical reasons, the pulp often contains small amounts of moisture.

It has been also noted that the curing temperature influences the bulk of the cured pulp product, i.e. a lower density may be obtained by increasing the curing temperature. Therefore, according to an embodiment of the invention, the curing temperature of the first pulp slurry can be from about 60° C. and up to about 150° C., preferably from 80 to 120° C., when the curing is performed by means of heated air/steam or by means of steam heated drying cylinders. The heated air or steam can be lead directly to heat the first pulp slurry or indirectly to heat the first pulp slurry, for example by means of air or steam heated cylinders. Suitably, the first pulp slurry is cured for a period of less than 3 hours at the specific temperature. The pulp slurry, which is in a form of a web or sheets gathered to bales continues to cure when it is rolled into a web roll or when stacked into bales of sheets, since the temperature of the pulp product decreases slowly, and this curing time can be also included in the curing period for less than about 3 hours.

Alternatively or additionally to the curing by means of heated air or steam or steam heated cylinders, the first pulp slurry can be cured by means of flash drying, also called swirl fluidising. Such driers are known in the art and provided e.g. by the company GEA Process Engineering A/S or Andritz AG. By using flash drying, the drying temperature can be higher than when drying by means of heated cylinders, and the temperature can be of from 100° C. to 300° C., depending on the sensitivity of the first pulp slurry to the curing conditions. Also the curing time can be shorter when flash drying is used. By flash drying a further bulking effect, i.e. a higher bulk with lower density, may be obtained, and a free-flowing material is obtained. Further, the bulk of the first pulp product may be further increased.

Thus, since the first pulp slurry containing the multivalent metal salt is cured before re-slushing it in a paper- or paperboard making process, it is possible to increase bulk and lower the water retention value significantly during the paperboard production. The pressing efficiency can be improved significantly and a higher dry content after the press section can be obtained and therefore less energy for drying is needed. The treatment suitably takes place in a pulp mill, and the pulp is used in a non-integrated paper/board mill, and therefore the resource efficiency will be much higher both in terms of material and energy efficiency at the non-integrated paper/paperboard mill.

The cured pulp product obtained in the step iv) can be provided in the form of a cured web or flakes. The cured web can be provided to a papermaking process as such and e.g. rolled into a web roll. The cured pulp product can alternatively be provided as a free flowing product if it has been cured by means of flash drying. Optionally, in the step x) the cured pulp product provided as a web can be cut into sheets. Alternatively, the flakes can be formed into sheets. The sheets can then be stacked to provide bales of pulp. The bales of pulp can then be easily transported to a paperboard mill and thus provided into a papermaking process.

The cured pulp product is used for the production of paperboard and thus in the next step of the process, step v), the cured pulp product is provided to a process for the production of paperboard, e.g. by transporting it to a paperboard mill. The cured pulp product is then subjected to re-slushing in a process step vi) to provide a second pulp slurry. In the step vii) the second pulp slurry and pulp slurries for the other layers of multi-layer paperboard are pumped to a wire section of a paperboard machine. The second pulp slurry and the pulp slurries for the other layers of multi-layer paperboard are then dewatered in a process step viii) and a web of pulp is provided. The web of pulp is then dried in a process step ix) and thus, a bulky paperboard comprising a middle layer of the cured pulp product of the present invention, the paperboard being suitable for use as a packaging board, is obtained. The paperboard may thus be produced by using existing equipment, and dry contents, additives and other papermaking process parameters known in the art can be used.

In the paperboard material comprising the bulking fibres treated with the aluminium metal salt containing aluminium ions there may be a risk that the bond strength (e.g. z-strength) between the fibres or other strength properties may be weakened. Thus, for example the z-strength of the paperboard, measured according to SCAN-P 80:98, may be weakened. In order to enhance the strength of paperboard made from bulking fibres, there are several different groups of suitable dry strength aids including, but not limited to, nanocellulosic materials, such as microfibrillar cellulose, cellulose nanofibrils, cellulose filaments, nanocrystalline cellulose, fines or fines-enriched-pulps, starch and gum derivatives, synthetic copolymers with acrylamide, such as acrylic acid, vinyl pyridine, 2-aminoethyl methacrylate, diallyl-dimethyl ammonium chloride, dimethyl-amino-propylacryl amide, diamine ethyl acrylate, styrene and glyoxalated polyacrylamides. The latter group is also suitably copolymerized with cationic monomers. Wet strength resins such as urea-formaldehyde resins, melamine-formaldehyde resins or polyamide-amine-epichlorohydrine resins are also useful in order to enhance the dry strength of bulking fibres. Such dry strength aids or wet strength resins are suitably added to the second pulp slurry during paperboard production, whereby the strength of the final paperboard product can be improved.

By the process a high quality paperboard with low density can be obtained. For example a structural density may be from about 150 kg/m³ to about 600 kg/m³ according to SCAN-P-88:01. The paperboard product comprises the middle layer as produced above to provide increased bulk and stiffness for the paperboard product.

The present process is especially suitable for use in paperboard mills/factories that are not integrated, i.e. factories in which pulping and papermaking are performed at the same site, since the curing step after metal-ion addition is essential for the bulking effect. For example, it is possible to transport the cellulosic pulp web in form of bales or rolls to a paperboard mill and re-slurry the bales or web in a headbox of a paperboard machine.

The invention will now be further described and illustrated in the following examples.

### EXAMPLES

The following exampled illustrate the effects of the present invention, but should not be regarded as limiting the scope of the invention in any way.

### Example 1

A never-dried bleached softwood kraft (SWBK) pulp (5 g/l, Husum kraft, Husum mill, M-real, Sweden) was cured with three different concentrations of AlCl₃, dewatered on a Buchner funnel to 25% by weight and cured at 120° C. for 2 h. The wet pulp was directly subjected to curing and was hence not pre-dried before curing. After re-slushing the cured pulp, the water retention value (WRV) was determined according to SCAN-C 62:00, after which Finnish hand-sheets (80 g/m², standard sheet-former, ISO 5269-1: 1998) were formed, pressed and dried and finally, the sheet density of the sheets was determined. The pressing was performed at 400 kPa for 5min. The results are displayed in table 1.

TABLE 1
The effect of AlCl₃ addition and a thermal treatment at
120° C. for 2 h on the sheet density of sheets made
from bleached softwood kraft pulp.

| | | | Structural |
|---|---|---|---|
| | | | density (kg/m³) |
| AlCl₃ (M) | pH | WRV.(g/g) | SCAN-P-88:01 |
| 0 | 5.46 | 0.709 | 425 |
| 0.001 | 4.08 | 0.586 | 353 |
| 0.002 | 3.96 | 0.557 | 348 |

From Table 1 it can be seen that the addition of AlCl₃ leads to a significant bulking of sheets, i.e. lowering of the density, made from the treated cured pulp.

### Example 2

In this example the effects of the curing temperature were investigated. Sample sheets were prepared in a similar manner as in connection with Example 1. Three different temperatures/curing times were tested: 20° C. (over-night), 80° C. (for 2 h) and at 120° C. (for 1 h).

The results are displayed in table 2.

TABLE 2
The effect of different drying temperatures/drying time
on the sheet density of sheets made from bleached softwood
kraft pulp. pH 4.08.

| | | | Structural |
|---|---|---|---|
| | Temp (° C.) and | | density (kg/m³) |
| AlCl₃ (M) | treatment time | WRV (g/g) | SCAN-P-88:01 |
| 0.001 | 20° C. (over-night) | 0.938 | 496 |
| 0.001 | 80° C. (2 h) | 0.887 | 488 |
| 0.001 | 120° C. (1 h) | 0.586 | 366 |

Firstly, normal drying of paperboard pulps also induce hornification of pulps. Hence, the never-dried SWBK has a WRV of around 1.4 g/g and decreases to 0.938 after room-temperature drying. The interesting result is, however, that by acid treatments in the presence of aluminium ions, a strong bulking effect is obtained.

It can be concluded from the results shown in table 2 that the higher the curing temperature is, the higher bulk will be obtained.

### Example 3

Sample sheets were prepared in a similar manner as in connection with Example 1, and a never-dried softwood bleached kraft pulp was dispersed in tap water at a pulp concentration of 5 g/l. A series of samples were prepared with various amounts of AlCl₃ (from 0 M to 0.005 M AlCl₃), after which the pH was adjusted with sulphuric acid to a pH value in the interval from pH 3.5 to pH 6.0. The so prepared samples were dewatered on a Buchner funnel to around 20% by weight pulp, after which the samples were cured in an oven at 120° C. for 2 h. The cured pulp was then re-slushed in tap water and the Water Retention Value (WRV, SCAN-C 62:00) was determined on the wet samples, after which hand sheets were formed in a Finnish hand-sheet former (80 g/m², standard sheet-former) according to standard ISO 5269-1:1998 except that the sheets were pressed between blotters at 400 kPa for 5 min and finally dried at 90° C. The structural density according to SCAN-P 88:01 was determined on the so prepared paper sheets.

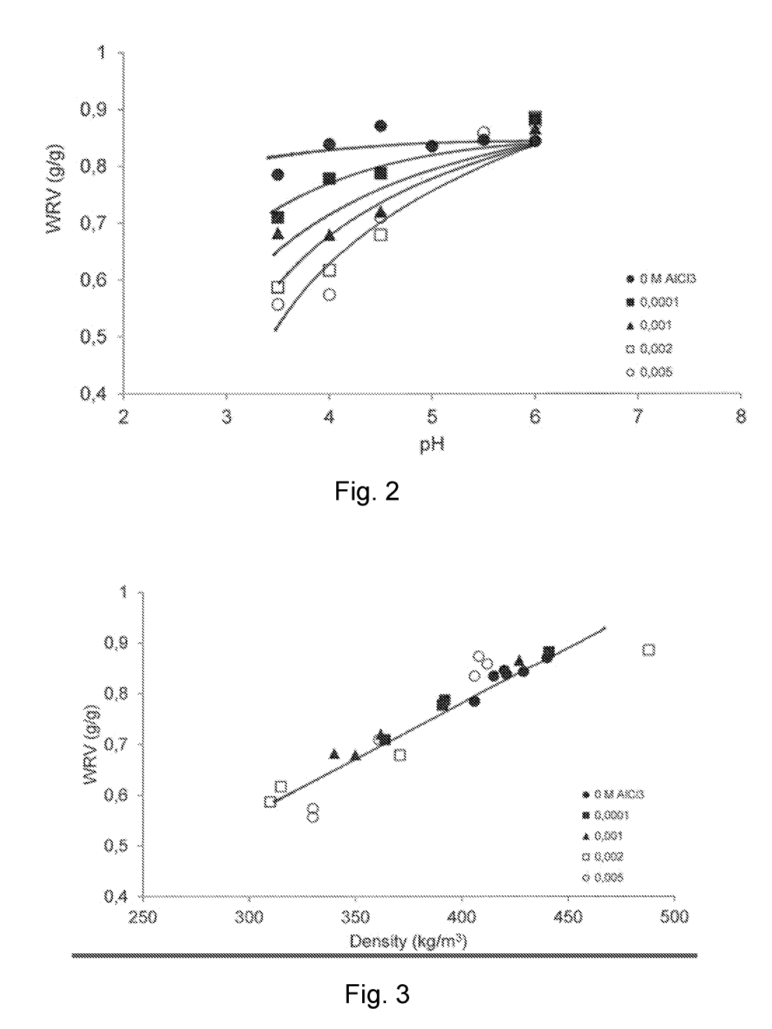

FIG. 2 shows the WRV versus the AlCl₃concentration and pH. From FIG. 2 it can be concluded that after the curing and re-slushing of the cured sheets, the lower the pH is and the higher the AlCl₃ concentration is, the lower is the WRV.

In FIG. 3 the structural density (SCAN-P 88:01) of the prepared hand sheets has been plotted vs. the WRV. It was found that there is a straight correlation between the structural density and the WRV before sheet forming. The example shows that heat treatment of pulp fibres with AlCl₃ at acidic pH-values decreases the WRV and increases the bulk (=1/sheet density) of formed sheets after such treatments.

### Example 4

In this example the treatment of fibres with AlCl₃ was compared with a treatment with Al₂(SO₄)₃, which is more common than AlCl₃ in papermaking applications. Hence a never-dried pulp slurry (5 g/l, Husum kraft, Husum mill, M-real, Sweden) was treated with 0.002 M AlCl₃ or 0.001 M Al₂(SO₄)₃ at pH 3.5 and heated and re-slushed as in Examples 1-3, after which WRV was determined.

Table 3 below shows that the pulps had a similar WRV and, hence the presence of the aluminium-ion is the important feature and not the counter-ion.

A further experiment was made by re-slushing a sample and giving it an acidic wash (pH 3). The WRV was determined and then brought to its Na-form at pH 9 and the WRV was determined. The example shows that the swelling is not affected by its ionic form and is therefore irreversible and, hence, useful for bulking of cellulosic fibre materials.

TABLE 3
WRV (g/g) of treated pulps in different ionic forms

| | WRV, | WRV at | WRV at |
|---|---|---|---|
| | pH = 3.5 | pH = 3 | pH = 9 |
| Pulp treatment | (Al form) | (H-form) | (Na-form) |
| 0.002M AlCl₃, pH = 3.5 | 0.65 | 0.65 | 0.68 |
| 0.001M Al₂(SO₄)₃ | 0.66 | — | — |
| pH = 3.5 | | | |

It is clear to the skilled person in the art that the invention may be varied in many ways within the scope of the appended claims. The examples and embodiments above are not intended to limit the scope of the invention in any way. Instead, the invention may be varied within the scope of the appended claims.

1. A process for the production of a multi-layer paperboard comprising at least three layers comprising a top layer, middle layer and bottom layer, the process comprising the steps of:
i) providing a first aqueous pulp slurry comprising cellulosic fibres and having a pulp consistency of from 0.1 to 40% by weight, calculated as dry weight of the cellulosic fibres in the first pulp slurry;
ii) adding to the first pulp slurry an aluminium metal salt comprising Al³⁺-ions to a total molar concentration of aluminium ions of from 0.0001 M to 0.5 M in the first pulp slurry;
iii) optionally adjusting the pH of the first pulp slurry to a pH of from pH 3.0 to pH 6.0;
iv) dewatering and curing the first pulp slurry at a temperature of at least 60° C. and thus provide a cured pulp product;
v) providing the cured pulp product to a process for the production of paperboard;
vi) re-slushing the cured pulp product to provide an aqueous second pulp slurry;
vii) pumping the second pulp slurry to a wire section of a paperboard machine to form the middle layer of the multi-layer paperboard, and pumping pulp slurries for the other layers of the multi-layer paperboard to the wire section of a paperboard machine;
viii) dewatering the second pulp slurry and the pulp slurries for the other layers of multi-layer paperboard and provide a web of pulp; and
ix) drying the web of pulp to provide a dried multi-layer paperboard.

2. The process according to claim 1, wherein in the step iv) of the process the first pulp slurry is cured by means of flash drying at a temperature of from 100° C. to 300° C., preferably from 150° C. to 270° C. and most preferably from 180° C. to 240° C.

3. The process according to claim 2, wherein the curing time is less than 5 minutes, preferably less than one minute.

4. The process according to claim 1, wherein in the step iv) of the process the first pulp slurry is cured at a temperature of from 60 to 150° C. by means of heated air or steam.

5. The process according to claim 4, wherein in the step iv) of the process the cured pulp product is provided in the form of a cured web.

6. The process according to claim 5, wherein the process further comprises a step x) comprising cutting the cured web of pulp into sheets and stacking the sheets to bales of pulp.

7. The process according to claim 1, wherein in the step iv) of the process the cured pulp product is cured until a moisture content of below 50%, preferably below 30% and most preferably below 15%, based on the total weight of the cured pulp product, is obtained.

8. The process according to claim 1, wherein in the step ii) of the process the metal salt containing Al³⁺ ions is added to the first pulp slurry to a total molar concentration of aluminium ions of from 0.0001 to 0.05 M in the first pulp slurry.

9. The process according to claim 1, wherein the pulp consistency of the first aqueous pulp slurry is of from 0.5 to 30%, preferably of from 1 to 20%, calculated as dry weight of the cellulosic fibres in the first pulp slurry.

10. The process according to claim 1, wherein the first aqueous pulp slurry comprises a pulp selected from a kraft, soda, sulfite, mechanical, thermomechanical, semi-chemical or chemi-thermomechanical pulp, recycled pulp or mixtures thereof.

11. The process according to claim 1, wherein the process further comprises adding a dry strength aid or a wet strength resin to the second pulp slurry.

12. A paperboard obtained by the process according to claim 1.

13. The paperboard according to claim 12, wherein the paperboard has a structural density of from 150 to 600 kg/m³ according to SCAN-P-88:01.
